(19) United States
(12) Patent Application Publication
(10) Pub. No.: US 2011/0221667 A1
(43) Pub. Date: Sep. 15, 2011

(54) APPARATUS AND METHOD FOR SWITCHING SCREEN IN MOBILE TERMINAL

(75) Inventor: Do-Kyou LEE, Suwon-si (KR)

(73) Assignee: SAMSUNG ELECTRONICS CO. LTD., Suwon-si (KR)

(21) Appl. No.: 13/043,904

(22) Filed: Mar. 9, 2011

(30) Foreign Application Priority Data
Mar. 9, 2010 (KR) 10-2010-0020681

(51) Int. Cl. G09G 5/00; G01B 7/30

(52) U.S. Cl. 345/156; 324/207.25

(57) ABSTRACT

An apparatus and a method for switching an output screen direction of a mobile terminal from a vertical direction to a horizontal direction, or from the horizontal direction to the vertical direction when needed are provided. The apparatus includes a sensor unit and a rotation determining unit. The sensor unit detects a direction of a magnetic field. The rotation determining unit determines a movement of the mobile terminal that rotates on a plane through the direction of the magnetic field detected by the sensor unit.

### PRIORITY

This application claims the benefit under 35 U.S.C. §119(a) of a Korean patent application filed in the Korean Intellectual Property Office on Mar. 9, 2010 and assigned Serial No. 10-2010-0020681, the entire disclosure of which is hereby incorporated by reference.

### BACKGROUND OF THE INVENTION

1. Field of the Invention

The present invention relates to an apparatus and a method for switching an output screen direction of a mobile terminal from a vertical direction to a horizontal direction, or from the horizontal direction to the vertical direction when needed. More particularly, the present invention relates to an apparatus and a method for detecting a motion that changes the screen of a mobile terminal under a situation where the acceleration of gravity does not change.

2. Description of the Related Art

Recently, mobile terminals have become necessities to modern people and are widely used regardless of age or sex. Because of their popularity, service providers and terminal manufacturers competitively develop products (or services) for differentiation from other companies.

For example, the mobile terminal has developed into a multimedia device capable of providing various services such as a phonebook, a game, a Short Message Service (SMS), an Electronic (E)-mail, a morning call, a Motion Picture Expert Group (MPEG)-1 or MPEG-2 Audio Layer-3 (MP3) player, a schedule management function, a digital camera, a wireless Internet service, and the like.

However, the mobile terminal supports only a fixed output direction and a user has an inconvenience when viewing contents on the output screen. For example, in the case where a user of the mobile terminal intends to use an E-book function of the mobile terminal, as a line change frequently occurs when the user uses a screen viewed at an upright position, that is, a portrait mode, the user has to frequently perform key input for changing a line.

To address the above problem, recently, a mobile terminal that supports a function for rotating the output screen of the mobile terminal according to a user's motion is brought to the market. Therefore, a user of the mobile terminal may change the output screen to a portrait mode or the output screen to a landscape mode through a simple operation.

However, since the general mobile terminal detects a user's motion that changes the output screen through a sensor (an acceleration sensor) for detecting the acceleration of gravity, it is impossible to determine the motion of the mobile terminal that rotates while it is placed on a plane.

For example, while the user places the mobile terminal on a table and uses an E-book function, the user may rotate the mobile terminal in order to rotate the output screen.

However, since the mobile terminal detects a motion by detecting the acceleration of gravity, the mobile terminal cannot detect the motion of the mobile terminal in the case where it rotates on the table and thus the change in the acceleration of gravity does not occur.

Therefore, to address the above problem, an apparatus and a method for detecting a rotation motion on a plane in the mobile terminal are required.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for detecting a motion according to a rotation on a plane in a mobile terminal.

Another aspect of the present invention is to provide an apparatus and a method for detecting a rotation on a plane using a sensor for detecting a magnetic field in a mobile terminal.

Still another aspect of the present invention is to provide an apparatus and a method for determining a rotation direction and a rotation angle using direction information of the North Pole obtained through a sensor for detecting a magnetic field in a mobile terminal.

In accordance with an aspect of the present invention, an apparatus for switching a screen of a mobile terminal is provided. The apparatus includes a sensor unit for detecting a direction of a magnetic field, and a rotation determining unit for determining movement of the mobile terminal that rotates on a plane through the direction of the magnetic field detected by the sensor unit.

In accordance with another aspect of the present invention, a method for switching a screen of a mobile terminal is provided. The method includes detecting a direction of a magnetic field through a sensor capable of detecting the magnetic field, and determining movement of the mobile terminal that rotates on a plane through the direction of the detected magnetic field.

In accordance with still another aspect of the present invention, an apparatus for switching a screen of a mobile terminal is provided. The apparatus includes a screen switching unit for obtaining current angle information of the North Pole and for determining a motion of the mobile terminal using the obtained current angle information of the North Pole, a controller for controlling the screen switching unit to determine a rotation direction and angle of the mobile terminal that rotates on a plane, and for controlling to rotate an output screen according to the determined rotation direction and rotation angle, and a display unit for outputting a rotated screen under control of the controller.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a mobile terminal for detecting a rotation motion on a plane according to an exemplary embodiment of the present invention;

FIG. 2 is a flowchart illustrating a process for detecting a motion of a mobile terminal that rotates on a plane in the mobile terminal according to an exemplary embodiment of the present invention;

FIG. 3 is a view illustrating an operation process of a mobile terminal that detects a motion of the mobile terminal that rotates on a plane according to an exemplary embodiment of the present invention;

FIG. 4A is a view illustrating a mobile terminal that determines a direction of a magnetic field according to an exemplary embodiment of the present invention;

FIG. 4B is a view illustrating a process for determining rotation of a mobile terminal according to an exemplary embodiment of the present invention;

FIG. 4C is a view illustrating a process for determining rotation of a mobile terminal according to an exemplary embodiment of the present invention;

FIG. 4D is a view illustrating a process for determining rotation of a mobile terminal according to an exemplary embodiment of the present invention; and

FIG. 5 is a view illustrating a process for detecting rotation on a plane in a mobile terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and a method for detecting a motion of a mobile terminal rotating on a plane.

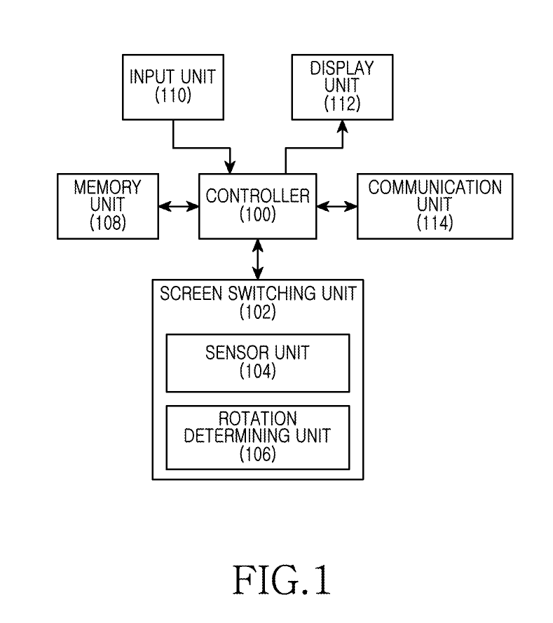

FIGS. 1 through 5, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 1 is a block diagram illustrating a mobile terminal for detecting a rotation motion on a plane according to an exemplary embodiment of the present invention.

Referring to FIG. 1, the mobile terminal includes a controller 100, a screen switching unit 102, a memory unit 108, an input unit 110, a display unit 112, and a communication unit 114. The screen switching unit 102 may include a sensor unit 104 and a rotation determining unit 106. The mobile terminal may include additional units that are not illustrated here merely for sake of clarity. Similarly, the functionality of two or more of the above units may be integrated into a single component.

The controller 100 of the mobile terminal controls an overall operation of the mobile terminal. For example, the controller 100 performs processes and controls for voice communication and data communication. In addition to the general functions, according to an exemplary embodiment of the present invention, the controller 100 determines a motion (a rotation direction and a rotation angle) of the mobile terminal using sensing information provided from a sensor that detects a magnetic field in order to address a problem that the conventional mobile terminal cannot detect a motion of rotating on a plane.

That is, the controller 100 receives current angle information of the North Pole from the sensor unit 104 that detects the magnetic field to determine a motion of the mobile terminal.

At this point, the controller 100 determines it has detected a normal motion only when the mobile terminal has rotated by a threshold or more using the sensing information provided from the sensor unit 104 to raise accuracy of screen rotation.

For example, on the assumption that a threshold for determining a motion is 80°, when detecting that a current angle for the North Pole is 82°, the controller 100 may determine a motion of the mobile terminal.

However, with the mobile terminal rotated as described above, when the mobile terminal rotates to a position at which a current angle with respect to the North Pole is 79° (rotates in the opposite direction by 3°), the controller 100 may detect the motion of the mobile terminal that has rotated in the opposite direction.

In this case, as there is high possibility that the above rotation is an abnormal motion, the controller 100 may determine a normal motion by setting a threshold for determining a clockwise rotation and setting a threshold for determining a counterclockwise rotation.

In addition, according to an exemplary embodiment of the present invention, when change in sensing information (a current angle with respect to the North Pole) is more than a predetermined range, the controller 100 may determine the motion of the mobile terminal.

The screen switching unit 102 determines an angle by which the mobile terminal has rotated using the North Pole under control of the controller 100, and determines the rotation direction and the rotation angle of the mobile terminal using the determined angle.

After that, the screen switching unit 102 determines whether a user of the mobile terminal has performed a motion for screen rotation using the determined rotation direction and rotation angle of the mobile terminal.

The sensor unit 104 of the screen switching unit 102 includes sensors for detecting a magnetic field and obtains current angle information of the mobile terminal with respect to the North Pole. The rotation determining unit 106 determines the rotation direction and the rotation angle of the mobile terminal using current angle information with respect to the North Pole obtained by the sensor unit 104. At this point, the rotation determining unit 106 determines the rotation direction and the rotation angle of the mobile terminal that rotates on a plane.

The memory unit 108 includes Read Only Memory (ROM), Random Access Memory (RAM), a flash ROM, and like. The ROM stores microcodes of programs for processes and controls of the controller 100 and the screen switching unit 102, and various reference data.

The RAM serves as a working memory of the controller 100 and stores temporary data that occur during execution of various programs. In addition, the flash ROM stores various updatable data for storage such as a phonebook, calling messages, received messages, information of a user's touch input point, and like.

The input unit 110 includes a plurality of function keys such as numerical key buttons of 0 to 9, a menu button, a cancel button, an OK button, a TALK button, an END button, an Internet access button, navigation key buttons, letter input keys, and like. The input unit 110 provides key input data (e.g., a screen switch request) corresponding to a key pressed by a user to the controller 100.

The display unit 112 displays status information generated during an operation of the mobile terminal, a limited number of letters, a large amount of moving and still images, and like. The display unit 112 may be a color Liquid Crystal Display (LCD), an Active Matrix Organic Light Emitting Diode (AMOLED), and the like. The display unit 112 may include a touch input device, and when it is applied to a touch input type mobile terminal, it can be used as an input unit.

The communication unit 114 transmits/receives a Radio Frequency (RF) signal of data input/output via an antenna (not illustrated). For example, during transmission, the communication unit 114 channel-codes and spreads data to be transmitted, and then performs an RF process on the signal to transmit the signal. During reception, the communication unit 114 converts a received RF signal into a baseband signal, and despreads and channel-decodes the baseband signal to recover data.

The function of the screen switching unit 102 may be performed by the controller 100 of the mobile terminal. The separate configuration and illustration of the screen switching unit 102 are exemplary and only for convenience in description, not for limiting the scope of the present invention. It would be obvious to those skilled in the art that various modifications may be made within the scope of the present invention. For example, all functions of the screen switching unit 102 may be processed by the controller 100.

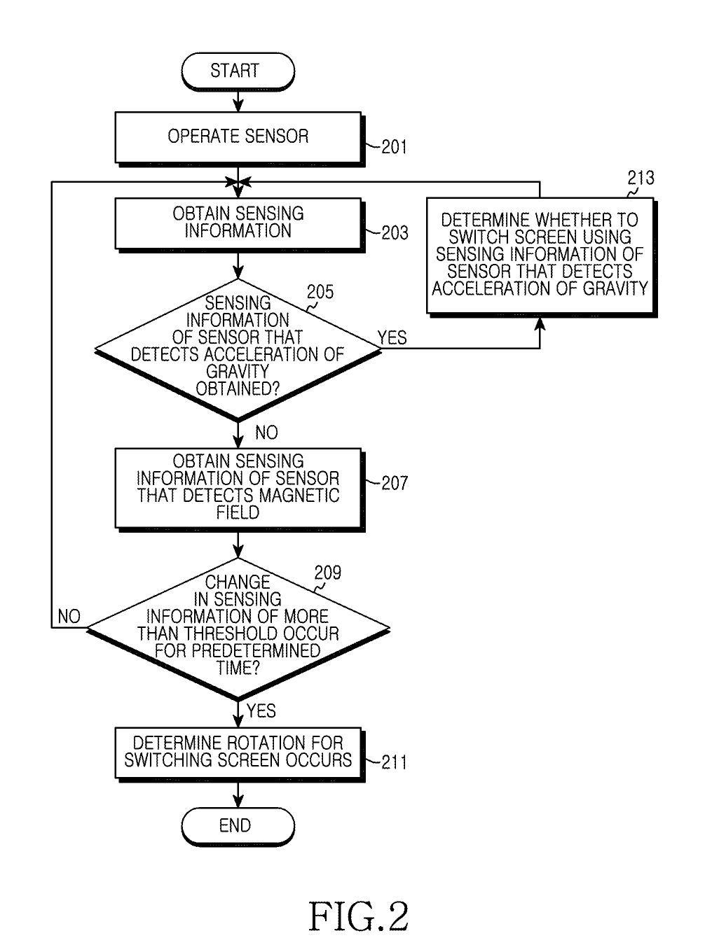

FIG. 2 is a flowchart illustrating a process for detecting a motion of a mobile terminal that rotates on a plane in the mobile terminal according to an exemplary embodiment of the present invention.

Referring to FIG. 2, the mobile terminal allows sensors to operate and obtain sensing information in step 201, and obtains the sensing information obtained by the sensors in step 203.

Here, the sensors operated in step 201 are used for a clock and a compass, and include a sensor (e.g., a compass sensor, and the like) for detecting a magnetic field. The sensors are used for detecting a motion occurring in a situation (on a plane) that is not influenced by the acceleration of gravity.

The mobile terminal proceeds to step 205 to determine whether sensing information of a sensor for detecting the acceleration of gravity is included in the sensing information obtained in step 203.

If it is determined in step 205 that the sensing information of the sensor for detecting the acceleration of gravity is included, the mobile terminal determines a motion using the sensing information of the sensor that has detected the acceleration of gravity to determine whether to switch a screen in step 213.

The sensing information of the sensor for detecting the acceleration of gravity is sensing information used for determining the motion of the general mobile terminal, and cannot detect the motion of the mobile terminal that rotates on a plane.

In contrast, if it is determined in step 205 that the sensing information of the sensor for detecting the acceleration of gravity is not included, the mobile terminal obtains sensing information of the sensor for detecting a magnetic field in step 207, and determines whether a change of more than a threshold in the sensing information occurs for a predetermined time in step 209.

Here, step 209 determines whether the obtained sensing information is sensing information obtained by normal rotation in order to raise accuracy of motion determination of the mobile terminal.

At this point, as described above, when the change in the sensing information (e.g., a current angle with respect to the North Pole) for the predetermined time is more than the threshold, the mobile terminal may determine a motion of the mobile terminal. According to an exemplary embodiment of the present invention, the mobile terminal may determine a normal motion by setting the threshold for determining a clockwise rotation and setting the threshold for determining a counterclockwise rotation.

If it is determined in step 209 that the change in the sensing information of less than the threshold occurs for the predetermined time, the mobile terminal determines that the sensing information has been obtained by an abnormal rotation and re-performs the process of step 203.

In contrast, if it is determined in step 209 that the change in the sensing information of more than the threshold occurs for the predetermined time, the mobile terminal determines that a rotation for switching the screen has occurred and the sensing information has been obtained by normal rotation in step 211.

After that, the mobile terminal ends the present algorithm.

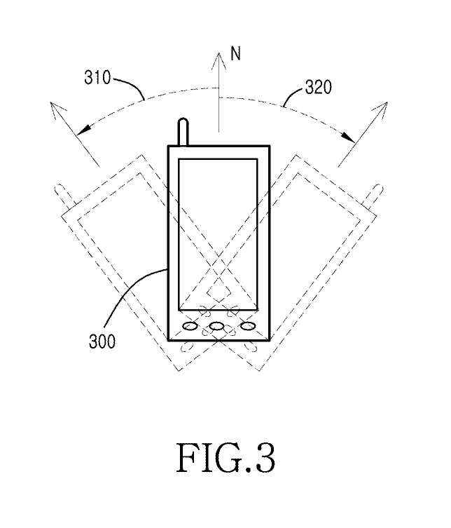

FIG. 3 is a view illustrating an operation process of a mobile terminal that detects a motion of the mobile terminal that rotates on a plane according to an exemplary embodiment of the present invention.

Referring to FIG. 3, the mobile terminal 300 has at least one sensor (e.g., a compass sensor, and the like.) that is used for a clock and a compass and can detect a magnetic field. The mobile terminal 300 is located on a plane (i.e., in FIG. 3, the mobile terminal is placed on the plane and viewed from above).

Generally, as the conventional mobile terminal detects a user's motion that changes the output screen through only a sensor (an acceleration sensor) for detecting the acceleration of gravity, it may not be possible to detect the motion of the mobile terminal rotating on a plane.

For example, as illustrated, in the case where a user rotates a mobile terminal in order to rotate an output screen while the user places the mobile terminal on a table and uses an E-book or other function, the mobile terminal cannot detect a change in the acceleration of gravity, so that the motion of the rotating mobile terminal cannot be detected.

Accordingly, the mobile terminal 300 according to an exemplary embodiment of the present invention can determine the direction (e.g., the North Pole) of the magnetic field using a sensor (e.g., a compass sensor) that can detect the magnetic field, and determine a current angle (e.g., a rotation angle) of the terminal with respect to the above determined North Pole.

For example, the mobile terminal 300 may determine an angle 310 rotated in a counterclockwise direction from the direction of the magnetic field to determine that the mobile terminal has rotated counterclockwise, and may determine an angle 320 rotated in a clockwise direction to determine a clockwise rotation.

At this point, the mobile terminal detects the motion of the mobile terminal by comparing the determined rotation angle with a first threshold and a second threshold.

The mobile terminal performs comparison of a rotation angle in a first direction (clockwise direction) and comparison of a rotation angle in a second direction (counterclockwise direction) using the first threshold and the second threshold, respectively, in order to prevent frequent motion determination.

Assuming that the threshold (the first threshold) is 80°, when determining that a current angle (an angle to the first direction) with respect to the North Pole is 82°, the mobile terminal may determine the motion of the mobile terminal.

However, in the case where the mobile terminal rotates (e.g., rotates in the opposite direction (the second direction) by 3°) to a position at which a current angle with respect to the North Pole is 79° from the above rotated state, this rotation may be an abnormal rotation, that is, not a rotation for switching the screen. Such an abnormal rotation may cause the screen to switch from a horizontal direction to a vertical direction (or vice versa) although the user does not desire such a switch, resulting in an inconvenience to the user.

To prevent motion detection for the above abnormal rotation, when detecting a rotation in the second direction after rotating in the first direction, the mobile terminal detects a rotation angle (an angle in the second direction) of more than 80° (the second threshold) from a current state to detect a motion for a normal rotation.

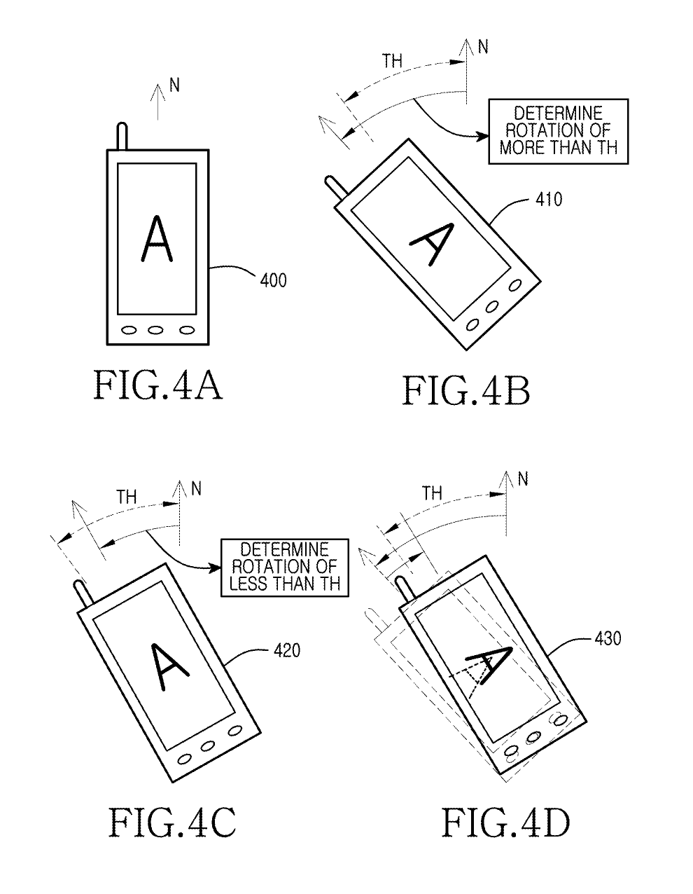

FIGS. 4A through 4D illustrate a process for changing an output screen according to a motion in a mobile terminal rotating on a plane according to an exemplary embodiment of the present invention.

FIG. 4A is a view illustrating a mobile terminal that determines a direction of a magnetic field according to an exemplary embodiment of the present invention.

Referring to FIG. 4A, the mobile terminal is placed on a plane, and has at least one sensor (e.g., a compass sensor) that is used for a clock and a compass and can detect a magnetic field.

Accordingly, the mobile terminal 400 may detect the direction of the magnetic field using the sensor, and determine an angle by which the mobile terminal rotates from the detected direction of the magnetic field to determine the motion of the rotating mobile terminal placed on the plane. At this point, the mobile terminal determines that the mobile terminal has rotated only when determining a rotation angle of more than a predetermined threshold.

FIG. 4B is a view illustrating a process for determining rotation of a mobile terminal according to an exemplary embodiment of the present invention.

Referring to FIG. 4B, the mobile terminal 410 determines in advance a threshold of an angle by which the mobile terminal 410 rotates from the direction of the magnetic field in order to determine a normal motion, and can detect a motion for a rotation of the mobile terminal 410 only when detecting a rotation angle of more than the threshold (TH).

The mobile terminal 410 that determines the rotation of more than the threshold rotates a currently output screen.

FIG. 4C is a view illustrating a process for determining rotation of a mobile terminal according to an exemplary embodiment of the present invention.

Referring to FIG. 4C, as described above, the mobile terminal 420 determines in advance a threshold of an angle by which the mobile terminal 420 rotates from the direction of the magnetic field in order to determine a normal motion, and may detect a motion for the rotation of the mobile terminal 420 only when detecting an angle of more than the threshold.

The mobile terminal 420 that has determined a rotation of less than the threshold does not detect a motion for a rotation and so maintains a currently output screen.

FIG. 4D is a view illustrating a process for determining rotation of a mobile terminal according to an exemplary embodiment of the present invention.

Referring to FIG. 4D, as described above, the mobile terminal 430 determines in advance a threshold of an angle by which the mobile terminal 430 rotates from the direction of the magnetic field in order to determine a normal motion, and may detect a motion for the rotation of the mobile terminal 430 only when detecting an angle of more than the threshold.

However, when detecting a motion for a rotation using a fixed threshold, the mobile terminal cannot determine whether it rotates normally.

More specifically, when defining a threshold of an angle by which the mobile terminal 430 rotates from the direction of the magnetic field as 80°, and detecting a rotation angle of more than the threshold, the mobile terminal 430 may determine a motion that switches the screen of the mobile terminal 430 from a vertical direction to a horizontal direction. Conversely, when detecting a rotation angle of less than the threshold, the mobile terminal 430 may determine a motion that switches the screen from the horizontal direction to the vertical direction.

However, in case of using the fixed threshold, when detecting that the mobile terminal 430 rotates by 81°, the mobile terminal 430 may switch the output screen from the vertical direction to the horizontal direction. However, in the case where the mobile terminal 430 unintentionally moves in the opposite direction by 2°, the mobile terminal 430 may switch the horizontally output screen to the vertical direction, which causes an inconvenience to the user.

To address this issue, the mobile terminal 430 detects the motion of the mobile terminal 430 using a first threshold (e.g., 80°) measured in a first direction, and a third threshold (e.g., 10°) measured in a second direction. That is, when rotating in the second direction after rotating in the first direction, the mobile terminal 430 detects the motion of the mobile terminal 430 by comparing the rotation angle with the third threshold from the state where the mobile terminal 430 has rotated in the first direction. Similarly, although not illustrated, the mobile terminal 430 detects the motion of the mobile terminal 430 using a second threshold (e.g., 80°) measured in a second direction, and a fourth threshold (e.g., 10°) measured in a first direction. That is, when rotating in the first direction after rotating in the second direction, the mobile terminal 430 detects the motion of the mobile terminal 430 by comparing the rotation angle with the fourth threshold from the state where the mobile terminal 430 has rotated in the second direction.

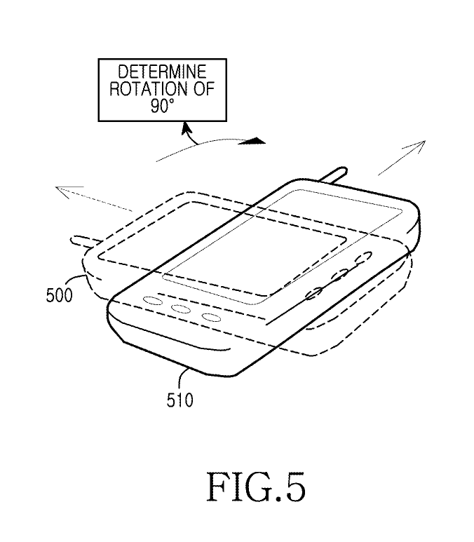

FIG. 5 is a view illustrating a process for detecting rotation on a plane in a mobile terminal according to an exemplary embodiment of the present invention.

Referring to FIG. 5, the mobile terminal may detect the direction (e.g., the North Pole) of the magnetic field using a sensor (e.g., a compass sensor) that can detect the magnetic field, and detect a current angle (e.g., a rotation angle) of the mobile terminal with respect to the detected North Pole.

When the mobile terminal 500 rotates by 90° as illustrated in 510, the mobile terminal may determine that it has rotated by 90° from the direction of the North Pole. The conventional mobile terminal that determines whether it has rotated using information of the acceleration of gravity cannot detect change in the acceleration on a plane and so cannot use a reference value for determining whether a rotation occurs, but the mobile terminal according to an exemplary embodiment of the present invention uses the direction of the North Pole as a reference value for determining whether a rotation occurs

As described above, exemplary embodiments of the present invention provide an apparatus and a method for detecting a motion that rotates the screen of a mobile terminal under a situation where the acceleration of gravity does not change in the mobile terminal. The mobile terminal can detect a rotation on a plane which has not been detected by the conventional mobile terminal by determining a rotation direction and a rotation angle using the direction information of the North Pole obtained through a sensor that detects the magnetic field.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for switching a screen of a mobile terminal, the apparatus comprising:
a sensor unit for detecting a direction of a magnetic field; and
a rotation determining unit for determining a movement of the mobile terminal that rotates on a plane through the direction of the magnetic field detected by the sensor unit.

2. The apparatus of claim 1, wherein the rotation determining unit determines a rotation angle of the mobile terminal that has rotated using the direction of the magnetic field, and detects a motion for switching the screen using the determined rotation angle of the mobile terminal to determine a movement of the mobile terminal rotating on the plane.

3. The apparatus of claim 2, wherein, when detecting the motion for switching the screen, a screen switching unit of the mobile terminal changes a direction of the output screen.

4. The apparatus of claim 2, wherein the rotation determining unit compares a rotation angle of the mobile terminal that rotates from the direction of the magnetic field with a first threshold when the mobile terminal rotates in a first direction, and compares a rotation angle of the mobile terminal that rotates from the direction of the magnetic field with a second threshold when the mobile terminal rotates in a second direction to detect a motion for switching the screen.

5. The apparatus of claim 4, wherein the rotation determining unit compares a rotation angle of the mobile terminal that rotated in the first direction with a third threshold when the mobile terminal rotates in the second direction, and compares a rotation angle of the mobile terminal that rotated in the second direction with a fourth threshold when the mobile terminal rotates in the first direction.

6. A method for switching a screen of a mobile terminal, the method comprising:
detecting a direction of a magnetic field through a sensor capable of detecting the magnetic field; and
determining a movement of the mobile terminal that rotates on a plane through the direction of the detected magnetic field.

7. The method of claim 6, wherein the determining of the movement of the mobile terminal that rotates on the plane through the direction of the detected magnetic field comprises:
determining a rotation angle of the mobile terminal that has rotated from the direction of the magnetic field; and
detecting a motion for switching a screen using the rotation angle of the mobile terminal.

8. The method of claim 6, further comprising, when determining the movement of the mobile terminal that rotates on the plane, changing a direction of an output screen.

9. The method of claim 7, wherein the detecting of the motion for switching the screen comprises:
determining a rotation direction of the mobile terminal;
when the mobile terminal rotates in a first direction, comparing the rotation angle of the mobile terminal that has rotated from the direction of the magnetic field with a first threshold; and
when the mobile terminal rotates in a second direction, comparing the rotation angle of the mobile terminal that has rotated from the direction of the magnetic field with a second threshold.

10. The method of claim 9, wherein the detecting of the motion for switching the screen further comprises:
when the mobile terminal has rotated in the first direction to a position greater than or equal to the first threshold and the mobile terminal rotates in the second direction, comparing the rotation angle of the mobile terminal in the second direction with a third threshold; and
when the mobile terminal has rotated in the second direction to a position greater than or equal to the second threshold and the mobile terminal rotates in the first direction, comparing the rotation angle of the mobile terminal in the first direction with a fourth threshold.

11. The method of claim 6, further comprising, determining if information of a sensor that detects the acceleration of gravity is available.

12. An apparatus for switching a screen of a mobile terminal, the apparatus comprising:
a screen switching unit for obtaining current angle information of the North Pole and for determining a motion of the mobile terminal using the obtained current angle information of the North Pole;
a controller for controlling the screen switching unit to determine rotation direction and rotation angle of the mobile terminal that rotates on a plane, and for controlling to rotate an output screen according to the determined rotation direction and rotation angle; and
a display unit for outputting a rotated screen under control of the controller.

13. The apparatus of claim 12, wherein the screen switching unit determines sensing information changing for a predetermined time to determine a motion of the mobile terminal.

14. The apparatus of claim 12, wherein the screen switching unit determines the motion of the mobile terminal by setting a first threshold for determining a clockwise rotation and a second threshold for determining a counterclockwise rotation.

15. The apparatus of claim 14, wherein the controller controls to rotate the output screen if the mobile terminal rotates by more than either the first or second threshold.

16. The apparatus of claim 15, wherein the screen switching unit compares a rotation angle of the mobile terminal that rotated in the clockwise direction more than the first threshold with a third threshold when the mobile terminal rotates in the counterclockwise direction, and compares a rotation angle of the mobile terminal that rotated in the counterclockwise direction more than the second threshold with a fourth threshold when the mobile terminal rotates in the clockwise direction.

17. The apparatus of claim 16, wherein the controller maintains the rotation of the output screen if the mobile terminal rotates by less than the third or fourth threshold.
